(19) United States
(12) Patent Application Publication
(10) Pub. No.: US 2005/0229324 A1
(43) Pub. Date: Oct. 20, 2005

(54) Process and auxiliaries for the treatment of organically tanned leather

(76) Inventors: Jens Fennen, Grezach-Wyhlen (DE); Wolfgang Herrmann, Freiburg (DE); Edith Quennet, Worms (DE)

Correspondence Address: WENDEROTH, LIND & PONACK, L.L.P., 2033 K STREET N. W., SUITE 800, WASHINGTON, DC, 20006-1021, US

(21) Appl. No.: 10/519,540

(22) PCT Filed: Jun. 16, 2003
(86) PCT No.: PCT/EP03/50230

§ 371 Date: Dec. 28, 2004

(30) Foreign Application Priority Data
Jun. 28, 2002 (CH) 1125/02
Nov. 7, 2002 (CH) 1872/02

(51) Int. Cl. C14C 1/00

(52) U.S. Cl. 8/94.15

(57) ABSTRACT

Organic polyamines having at least three amino groups in the molecule or mixtures, or reaction products (1) of such polyamines with (2) at least one alkylsilane having organic oxy radicals bonded to the silicon atom and a functional group bonded to the alkyl group, so that said reaction products have at least two free amino groups in the molecule, said functional group forming a covalently bonded bridging group with an amino group of the polyamine, are suitable as cationic auxiliaries in the finishing of leathers and skins, pretanned with dialdehydes and retanned with organic tanning agents, with anionic auxiliaries, such as, for example, anionic dyes.

The present invention relates to a process for the treatment of leather and skins (also referred to below as “wet white” leather), tanned exclusively with dialdehydes and with organic tanning agents, with anionic auxiliaries with addition of organic polyamines, optionally as a mixture with functional alkylsilanes, or with reaction products of organic polyamines and functional alkylsilanes; and mixtures or reaction products of functional alkylsilanes and organic polyamines.

The proportion of leathers tanned exclusively with organic tanning agents has increased continuously in recent years. This is due in particular to the considerable increase in the production of “wet white” leathers. This is understood as meaning a leather which is pretanned with aldehydes, in particular glutaraldehyde, and can be mechanically processed and has a sufficient storage stability. This pretanned leather is then completely tanned with large amounts of anionic synthetic and vegetable retanning agents in order to obtain a final article having the desired performance characteristics, such as body, grain structure, softness and handle.

For the treatment of tanned leathers with anionic auxiliaries, cationic auxiliaries are frequently used for fixing them.

CH-A-676012 proposes long-chain alkylaminoalkylene oxide adducts having esterified terminal hydroxyl groups as auxiliaries for the dyeing of leather, in order to improve the colour fastness. Owing to the reaction with the alkylene oxides, the adducts are considered to be uneconomical. The adducts contain relatively few amino groups, and leather substrates can therefore be pretreated with the adducts without substantially hindering the desired penetration of anionic dyes (positive charge of the leather substrate).

EP-A-0 432 686 describes condensates of polyalkylenepolyamines, alkylated or alkenylated hydroxyaromatics and formaldehyde as auxiliaries for improving the penetration of anionic dyes into the leather. Here too, the leather is treated, prior to dyeing, with a composition which contains relatively few amino groups and with which the dyeing of both the surface and the interior region of the leather substrate is to be achieved.

EP-A-0 057 398 describes polyethers of aminodialkanols as auxiliaries for the aftertreatment of fibre materials having a nonfelting finish, in particular wool.

DE-A3517804 proposes optionally oxaalkylated polyalkylenamines as auxiliaries for dyeing differently tanned, for example chrome tanned or vegetable tanned, leather. The pretanning with dialdehydes and the particular difficulties of the treatment of such leathers with anionic auxiliaries are not discussed.

It has also already been proposed to use functionalized cationic auxiliaries which bind to or are deposited on the fibres of the substrate, in order to avoid these disadvantages. U.S. Pat. No. 3,653,952 and WO 00/77292 describe the use of aminoalkylsilanes as dyeing auxiliaries for fibrous materials, including leather. In U.S. Pat. No. 3,741,721 aminoalkylsilanes are used for fixing the anionic dye after the dyeing of fibrous substrates. Although improvements are obtained with the aminoalkylsilanes, disadvantages also have to be accepted. The fixing of the dyes is improved but is still insufficient with regard to the colour fastness. Furthermore, it is difficult to obtain a uniform dyeing without redyeing operations. An undesired hardening of the leather surface is also observed. The aminoalkylsilanes have to be used in relatively large amounts, which prevents industrial use owing to the expensive chemicals.

In comparison with chrome leather, which still accounts for by far the predominant proportion of world leather production, wet white leather has a substantially more anionic character. As a result of this, anionic auxiliaries, such as dyes, fatliquoring agents and tanning agents, are fixed considerably more poorly on the substrate. This is evident, inter alia, in the substantially poorer physical fastnesses compared with chrome leather and in the poorer exhaustion of the auxiliary liquors.

To date, the poor fastness to perspiration has prevented more widespread use of wet white leathers. In the case of chrome leathers, the dye fixing, which is in any case better, can be further improved by the use of commercial cationic auxiliaries so that in most cases adequate fastnesses can be achieved. In the case of wet white leathers, this problem is more difficult to solve because many known cationic fixing agents result as a rule in only an insubstantial improvement in the in any case substantially poorer fastness to perspiration.

It has now surprisingly been found that, in the case of leathers pretanned with dialdehydes and retanned with organic (anionic) compositions, considerably stronger fixing of anionic auxiliaries, for example anionic dyes, in comparison with commercial fixing agents is achieved and an unexpectedly substantial improvement of the fastnesses, in particular the fastnesses to perspiration, is achieved if organic polyamines having at least three amino groups in the molecule, or mixtures or reaction products of such polyamines with functional alkylsilanes, are used as fixing agents. Furthermore, by means of such compositions, even a dyeing which is more uniform over the surface and more intense is achieved, hardening of the surface is avoided and in addition a filling and retanning effect is observed in the case of leather.

The invention first relates to a process for the treatment of leathers or skins, pretanned with dialdehydes and retanned with organic tanning agents, with anionic reagents in an aqueous liquor, in which
a) either an anionic reagent together with at least one organic polyamine having at least three amino groups in the molecule, or mixtures or reaction products (1) of such polyamines with (2) at least one alkylsilane having organic oxy radicals bonded to the silicon atom and a functional group bonded to the alkyl group so that said reaction products have at least two free amino groups in the molecule, said functional group forming covalently bonded bridging groups with an amino group of the polyamine, are added to the liquor and allowed to act on the leather,
b) or the leather is first treated with anionic reagents and then, in the same or a fresh liquor, at least one organic polyamine having at least three amino groups in the molecule, or mixtures or reaction products (1) of such polyamines with (2) at least one alkylsilane having organic oxy radicals bonded to the silicon atom and a functional group bonded to the alkyl group so that said reaction products have at least two free amino groups in the molecule, said functional group forming a covalently bonded bridging group with an amino group of the polyamine, is or are allowed to act on the treated material,
c) or the leather is first treated with an organic polyamine having at least three amino groups in the molecule, or mixtures or reaction products (1) of such polyamines with (2) at least one alkylsilane having organic oxy radicals bonded to the silicon atom and a functional group bonded to the alkyl group so that said reaction products have at least two free amino groups in the molecule, said functional group forming a covalently bonded bridging group with an amino group of the polyamine, and the anionic reagents are then allowed to act on the treated material in the same or a fresh liquor.

The organic polyamines used can be modified with epoxides, for example alkylene oxides or glycidyl ethers, and contain at least one hydroxyalkyl and/or hydroxypolyoxaalkyl group bonded to N atoms. Examples of alkylene oxides are in particular ethylene oxide and propylene oxide. The hydroxypolyoxaalkyl group may contain, for example, 2 to 30, preferably 2 to 20 and particularly preferably 2 to 10, oxaalkylene groups. Such modified polyamines are known and some of them are commercially available. If the polyamines are modified with epoxides, they preferably contain at most up to 20, more preferably up to 10 and particularly preferably up to 5, percent by weight of hydroxyalkyl and/or hydroxypolyoxaalkyl groups, based on the total amount of polyamine and epoxide. In a particularly preferred embodiment, the polyamines are unmodified. Furthermore, the organic polyamines contain no quaternary ammonium groups.

The production of wet white leather is generally known and widely described in the literature, for example by A. Püntener and N. Gschwind in Das Leder [Leather], 45, 18-23, 1994, and by G. Wolf, M. Breth, J, Carle and G. Igl in Journal of the American Leather Chemists Association, 96, 111-119, 2001. Dialdehydes, for example aliphatic, cycloaliphatic or aromatic dialdehydes, which have altogether 2 to 18, preferably 2 to 12 and particularly preferably 3 to 8, carbon atoms are used for the pretanning of hides and skins. In particular, glutaraldehyde has become established in the industrial production.

Examples of retanning agents are anionic sweetened or unsweetened vegetable tanning agents, anionic and aromatic syntans, anionic polymer tanning agents, polyphosphates, lignin tanning agents, anionic resin tanning agents and anionic polyurethane ionomers and anionic fluorine compounds (Bibliothek des Leders [Leather Library], edited by Hans Herfeld, Volume 3 “Gerbmittel, Gerbung, Nachgerbung” [Tanning agents, tanning, retanning], Kurt Faber).

Suitable vegetable tanning agents are, for example, tanning agents which are obtained from constituents of mimosa, quebracho, tara, oak, chestnut, gambir, sumach or spruce. Vegetable tanning agents which contain pyrogallol or pyrocatechol are particularly suitable.

Suitable anionic, aromatic syntans are, for example, those compounds which are obtainable by condensation of sulphonated aromatic compounds alone or together with further, generally unsulphonated aromatic compounds with formaldehyde and/or urea.

Aromatic compounds suitable for this purpose are, for example, naphthalene, biphenyl, terphenyl, phenols, cresols, 4,4′-dihydroxydiphenyl sulphone, β-naphthol, dihydroxybenzenes, resorcinol, 2,2′-bis(hydroxyphenyl)propane and diaryl ethers, such as diphenyl ether and ditolyl ether, which were optionally sulphonated in a manner known per se.

Particularly suitable anionic aromatic syntans are the following compounds:
(I) condensates of sulphonated phenol or cresol and formaldehyde,
(II) condensates of naphthalenesulphonic acid and formaldehyde,
(III) formaldehyde condensates of 4,4′-dihydroxydiphenyl sulphones with arylsulphonic acids or (hydroxy)arylsulphonic acids,
(IV) formaldehyde condensates of aromatic hydroxy compounds containing sulpho groups with aralkyl halides,
(V) urea-formaldehyde condensates of phenols and phenolsulphonic acids,
(VI) reaction products of phenol and a sulphonating agent, the molar (phenol):(SO₃) ratio being (1):(1.1-2.2),
(VII) condensates of sulphonated diaryl ethers and formaldehyde,
(VIII) condensates of sulphonated di- or terphenyls and formaldehyde,
(IX) condensates of 4,4′-dihydroxydiphenyl sulphone and sulphonated 4,4′-dihydroxydiphenyl sulphone with formaldehyde,
(X) formaldehyde condensates of diaryl ether sulphonic acids and 4,4′-dihydroxydiphenyl sulphone and
(XI) formaldehyde condensates of phenol with arylsulphonic acids or hydroxyarylsulphonic acids.

These condensates are present in the form of the free acids, preferably in the form of the sulphonic acids, or as salts, especially ammonium, lithium, potassium or, in particular, sodium salts.

These condensates are known, for example, from Ullmanns Enzyklopadie der technischen Chemie [Ullmann's Encyclopaedia of Industrial Chemistry], Vol. 16, (4), pages 138 to 140 (1979), or can be prepared by the processes described in the references given there.

Suitable resin tanning agents are the anionic compounds which are obtained if condensates of nitrogen-containing organic compounds, such as, for example, urea, thiourea, dicyandiamide or melamine, are condensed with formaldehyde or other simple oxo compounds and anionic compounds, such as, for example, phenols, alkali metal salts of aromatic sulphonic acids, sulphonamides, ligninsulphonates, sulphite or hydrogen sulphite.

The polymeric retanning agents are, for example, poly(meth)acrylates, copolymers containing (meth)acrylates or maleic acid.

These retanning agents are known and many of them are commercially available.

Anionic reagents for the finishing of fibrous materials are, for example, fatliquoring agents, water repellents, retanning agents, dyes and further auxiliaries. Anionic reagents contain at least one acidic group, for example COOH, SO₃H, SO₂H, PO(OH)₂ or POOH, which may be present in the form of salts, for example as Na, K or NH₄ salts.

Anionic auxiliaries are generally added to the liquor in amounts of from 0.1 to 30, preferably 0.1 to 20 and particularly preferably 0.1 to 10,% by weight, based on the shaved weight of the leather or of the skin.

Examples of fatliquoring agents and water repellents are reaction products of animal, vegetable or synthetic fats, oils or waxes which are obtained by means of sulphation, sulphitation, sulphonation, hydrolysis or oxidation; synthetic anionic fatliquoring agents having the abovementioned functional groups; fatliquoring agents and water repellents which contain anionic auxiliaries, for example emulsifiers or polymers having the abovementioned functional groups, and anionic functional silicones or fluorine compounds (Bibliothek des Leders [Leather Library], edited by Hans Herfeld, Volume 4 “Entfetten, Fetten, Hydrophobieren bei der Lederherstellung” [Degreasing, fatliquoring, imparting water repellency in leather production], Martin Hollstein, and EP 1 087 021 A1).

Examples of further auxiliaries are anionic polymers and aromatic syntans as neutralizing agents or dispersants, phosphoric esters as flameproofing agents and tear strength improvers and amphoteric auxiliaries (Bibliothek des Leders [Leather Library], edited by Hans Herfeld, Volume 3 “Gerbmittel, Gerbung, Nachgerbung” [Tanning agents, tanning, retanning], Kurt Faber).

The process according to the invention is suitable in particular for the dyeing of leathers and skins with anionic dyes, process variant b) preferably being used.

Preferred dyes may correspond to the formula I
Dye-(X-Z)_{y} (I),
in which
dye is the skeleton of a water-soluble, organic or organometallic dye,
X is a direct bond or a divalent bridging group,
Z is an anionic group and
y is a number from 1 to 10.

The bridging group is preferably C₁-C₁₂alkylene, which may be interrupted by O, S or NR, in which R is H or C₁-C₄alkyl.

In formula I, X is preferably a direct bond.

In formula I, Z is preferably —OH, —COOH, —SO₃H and —PO₃H, and the alkali metal, alkaline earth metal and ammonium salts thereof.

In formula I, y is preferably a number from 1 to 6, particularly preferably from 1 to 4.

Suitable dyes are mentioned in the Colour Index and are familiar to a person skilled in the art. Some examples are Acid Black 210, Direct Black 168, Acid Black 172, Acid Brown 75, Acid Brown 191 and other acid and direct dyes, in particular from the group consisting of the azo dyes and of the azo dyes complexed with metals.

The polyamines to be used according to the invention may be low molecular weight, oligomeric or polymeric compounds which are preferably soluble in polar solvents and also in water. The compounds may have molecular weights of from 60 to 1 000 000, preferably from 100 to 500 000, more preferably from 150 to 200 000 and particularly preferably from 200 to 50 000 Dalton.

The amino groups for the formation of reaction products (free amino groups) may be —NH₂, —NH(C₁-C₆alkyl) or —NH—, and —N(C₁-C₆alkyl)- or —N(C₁-C₆alkyl)₂ may additionally be present, it being possible for the compounds to contain identical or different amino groups from among these amino groups. C₁-C₆Alkyl may be linear or branched. C₁-C₄Alkyl is preferred. Examples of alkyl are methyl, ethyl, n-propyl, isopropyl, n-butyl, pentyl and hexyl. Particularly preferably, the free amino groups are identical or different groups which are selected from —NHCH₃, —NHC₂H₅ and particularly preferably —NH₂ and —NH—. Additionally present amino groups are preferably —N(CH₃)₂, —N(CH₃)—, —N(C₂H₅)₂ or —N(C₂H₅)—.

Depending on the pH of a liquor, the amino groups of the polyamines to be used may be present in the form of salts of inorganic or organic acids, for example formates, acetates, halides (chlorides), sulphates, phosphates, sulphonates or phosphonates.

The low molecular weight polyamines may be saturated or unsaturated, open-chain, mono- or polycyclic compounds which preferably contain 6 to 30, particularly preferably 6 to 20, C atoms and which are unsubstituted or substituted by radicals inert to treatment liquors. The carbon chain may be interrupted by hetero atoms, preferably from the group consisting of —O—, —S—, ═N— and —NR′—, in which R′ is H, C₁-C₆alkyl, preferably C₁-C₄alkyl, C₅-C₈cycloalkyl, such as, for example, cyclopentyl, cyclohexyl or cyclooctyl, C₆-C₁₀aryl, such as, for example, phenyl or naphthyl, or C₇-C₁₂aralkyl, such as, for example, phenylmethyl or phenylethyl. The low molecular weight polyamines preferably contain 3 to 8, more preferably 3 to 6 and particularly preferably 3 or 4, amino groups, which may also be present as group —NR′— in a heterocyclic ring.

Examples of low molecular weight polyamines are propanetriamine, butanetriamine, hexanetriamine, octanetetramine, polyalkylenepolyamines, such as diethylenetriamine, triethylenetetramine, cyclohexanetriamine, cyclooctanetriamine, cyclooctantetramine, diaminopyrrolidine, diaminopiperazine, triaminobenzene, tri- or tetraaminobiphenyl, tri- or tetraaminobiphenyl ether, tri- or tetraaminobiphenyl thioether, tri- or tetraaminobiphenylamine, tri- or tetraaminonaphthalene, tri- or tetraaminoazobenzene, isophoronetriamine and diaminoindole.

The polyamines having at least 3 amino groups may be oligomers or polymers in which the amino groups are bonded either directly or via a bridging group to the polymer backbone. Such polymers are known and some of them are commercially available. The polymers and oligomers are substantially polymers or polycondensates. The oligomers and polymers may also be those which contain amino groups in the polymer backbone. In the context of the invention, oligomers are understood as meaning polyamines having 3 to 100, preferably 3 to 50 and particularly preferably 3 to 30 identical or different monomer units. The polymers may contain more than 100 and up to about 28 000, preferably up to 14 000 and particularly preferably up to 6 000 identical or different monomer units. They may be homo- or cooligomers or homo- or copolymers.

Oligomeric and polymeric polyamines are known and can be prepared by known processes.

The oligomers and polymers may be derived from monomers containing amino groups, such as, for example, vinylamine, allylamine, 4-aminostyrene, amino-C₂-C₆alkyl esters or amino-C₂-C₆alkylamides of ethylenically unsaturated carboxylic acids, amino-C₂-C₆alkyl ethers of vinyl alcohol and di- or triaminocarboxylic acids, such as lysine. Oligomers or polymers based on such monomers are known or can be prepared in a manner known per se, directly by polymerization or subsequent modification of oligomers or polymers, such as, for example, esterification, transesterification, amidation or transamidation of polymeric unsaturated polycarboxylic acids or their esters and amides with aminoalkyl alcohols or alkyldiamines. Ethers of vinyl alcohols are obtainable by reacting polyvinyl alcohol with aminoalkyl halides or aminoalkyl epoxides. Polyvinylamines are obtainable by polymerization of, for example, vinylacetamide and subsequent hydrolysis. The ethylenically unsaturated carboxylic acids are preferably acrylic acid, methacrylic acid and maleic acid. For the preparation of oligomers, the polymerization can be terminated or a chain terminating agent may be used.

Comonomers suitable for the oligomers and polymers are, for example, C₂-C₁₈alkenes, vinyl chloride, vinylidene chloride, tetrafluoroethylene, styrene, vinylpyrrolidone, maleic acid and esters and amides thereof, acrylic acid and methacrylic acid and esters and amides thereof, vinyl esters and vinyl ethers, and vinylamides of carboxylic acids.

The oligomers and polymers may also contain structural elements of comonomers having other functional groups which are capable of reacting with functional groups of the alkylsilanes. Examples of such functional groups have been mentioned above. In addition, the thiol and in particular the hydroxyl group are suitable. Suitable comonomers are, for example, vinyl alcohol, β-hydroxyethyl vinyl ether, β-hydroxyethyl acrylate, β-hydroxyethyl methacrylate, β-hydroxyethylacrylamide or β-hydroxyethylmethacrylamide. Whether and the extent to which the functional groups react only with amino groups, only with other functional groups or with both types of functional groups depends on the reactivity of said functional groups with respect to other functional groups. This is not essential for the activity of the compounds according to the invention and containing amino groups, since it is mainly the covalent bonding of the alkylsilanes that is important.

Preferred polyamines to be used according to the invention are oligomers and polymers having at least one repeating structural element of the formula II and optionally at least one repeating structural element of the formula III 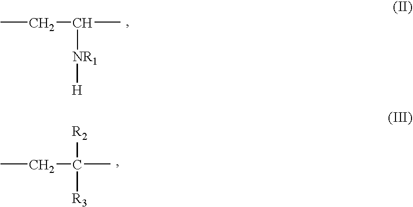
in which
R₁ is H or C₁-C₄alkyl,
R₂ is H or methyl,
R₃ is H, C₁-C₁₇alkyl, phenyl, methylphenyl, pyrrolidinyl, Cl, —O—C₁-C₄alkyl, —O—(CO)—C₁-C₄alkyl, —C(O)—OR₄ or —C(O)—NR₅R₆,
R₄ is H or C₁-C₁₈alkyl and
R₅ and R₆, independently of one another, are H or C₁-C₄alkyl.
R₁ is preferably H or methyl, R₃ and R₄ as alkyl may be linear or branched.

The amount of structural elements of the formula II may be, for example, from 0.1 to 100 mol %, preferably from 2 to 50 mol %, more preferably from 3 to 30 mol % and particularly preferably from 5 to 20 mol %, based on 1 mol of an oligomer or polymer. The amount of structural elements of the formula III may be, for example, from 0 to 99.9 mol %, preferably from 50 to 98 mol %, more preferably from 70 to 97 mol % and particularly preferably from 80 to 95 mol %, based on 1 mol of an oligomer or polymer. The properties of the oligomers and polymers and the performance characteristics thereof can be influenced by the content of structural elements of the formula III.

Depending on the preparation process, oligomers and polymers may also have different proportions of branches, which however do not present any problems.

In the process according to the invention, oligomers which may contain from 3 to 30, preferably from 3 to 20, more preferably from 3 to 15 and particularly preferably from 3 to 10 structural elements of the formula II and optionally structural elements of the formula III are preferably used. The preferred oligomers may be random mixtures of molecules of different chain length. In a particularly preferred embodiment, these oligomers contain structural elements of the formula II and structural elements of the formula III, it being possible for the content of repeating structural elements of the formula II to be from 1 to 100 mol %, preferably from 5 to 80 mol % and particularly preferably from 5 to 50 mol % and the content of repeating structural elements in formula III accordingly to be from 99 to 0 mol %, preferably from 95 to 20 mol % and particularly preferably from 95 to 5 mol %, based on 1 mol of the oligomer or mixture of oligomers, without including the terminal groups.

The oligomers and polymers to be used according to the invention and having amino groups in the oligomer or polymer backbone may be adducts of aliphatic cyclic amines having 2 to 4, preferably 2 or 3, C atoms in the ring, with organic amines which contain at least two amino groups —NH(C₁-C₄alkyl) or preferably —NH₂. The cyclic amines may be pyrrolidine, azetidine or aziridine, the carbon atoms of which may be substituted by C₁-C₄alkyl. Aziridine and methylaziridine are particularly preferred. Suitable organic amines are those which contain an organic hydrocarbon radical having 2 to 30, preferably 2 to 20 and particularly preferably 2 to 12 C atoms, which may be interrupted by hetero atoms from the group consisting of —O—, —S— or —NR′—, and to which at least one, preferably 1 to 6, particularly preferably 1 to 4 and in particular two or three amino groups —NH(C₁-C₄alkyl) or —NH₂ are bonded, the group —NH₂ being preferred. R′ is H or C₁-C₄alkyl, for example methyl.

The organic hydrocarbon radical may be aliphatic, cycloaliphatic, aromatic or heteroaromatic radicals, for example C₁-C₂₂alkyl, C₂-C₂₂alkenyl, C₂-C₂₂alkylene, C₄-C₂₂alkenylene, C₃-C₁₂cycloalkyl, C₃-C₁₂heterocycloalkyl having hetero atoms selected from the group consisting of —O—, —S— or —NR′— where R′ is H or C₁-C₄alkyl, C₁-C₄alkylene-C₃-C₁₂cycloalkyl, C₁-C₄alkylene-C₃-C₁₂cycloalkyl-C₁-C₄alkylene, C₆-C₁₂aryl, C₁-C₄alkylene-C₆-C₁₂aryl, C₁-C₄alkylene-C₆-C₁₂aryl-C₁-C₄alkylene, C₅-C₁₁heteroaryl having hetero atoms selected from the group consisting of —O—, —S— or —NR′— where R′ is H or C₁-C₄alkyl, C₁-C₄alkylene-C₅-C₁₁heteroaryl and C₁-C₄alkylene-C₅-C₁₁heteroaryl-C₁-C₄alkylene and corresponding trivalent to hexavalent hydrocarbon radicals.

The organic hydrocarbon radical may be unsubstituted or substituted, for example by halogen (F, Cl or Br), C₁-C₄alkyl or C₁-C₄alkoxy.

Organic amines are known in large numbers to a person skilled in the art. The following may be mentioned as examples: C₁-C₂₂alkylamines (methylamine, ethylamine, octylamine, dodecylamine, octadecylamine, eicosylamine, C₂-C₂₂alkenylamines (fatty amines, such as oleylamine), C₂-C₂₂alkylenediamines (ethylenediamine, 1,2- or 1,3-propylenediamine, butylenediamine, hexylenediamine, octylenediamine, decylenediamine, dodecylenediamine, octadecylenediamine, cyclopentylamine, cyclohexylamine, methylcyclohexylamine, N-methylaminopyrrolidine, aminomethyl- or aminoethylcyclohexane, di(aminomethyl)- or di(aminoethyl)cyclohexane, aminopiperidine, cyclohexylenediamine, aniline, nonylaniline, diaminobenzene, 4,4′-diaminobiphenyl, triaminobenzene and isophoronetriamine.

The preparation of the adducts is generally known. Depending on the reaction conditions and ratio of organic to cyclic amines and number of amino groups in the organic amine, linear and branched products up to dendrimers can form. The molecular weight can be controlled via the addition of chain terminators, for example monoamines, alkanols and thiols. Reaction initiators which effect ring opening of the cyclic amines, for example strongly nucleophilic substances, such as alkali metal alcoholates or alkali metal amides, can be added for accelerating the reaction. In the addition reaction, random oligomers and polymers are formed.

Adducts of organic mono- to tetramines, in particular organic diamines, and aziridine, are preferred. The latter preferably contain repeating structural elements of the formula IV and optionally repeating structural elements of the formula V,
—(NR₁₆CH₂—CH₂)— (IV),
—NR₁₆—R₇—NR₁₆— (V),
terminal groups R₈ being bonded to the ends of the chains, in which
R₇ is C₂-C₁₂alkylene, C₅-C₈cycloalkylene or C₆-C₁₀arylene,
R₈ is hydrogen, C₁-C₁₈alkoxy or C₁-C₁₈alkylamino and
the R₁₆, independently of one another, are H or C₁-C₄alkyl.

R₇ as alkylene is preferably C₂-C₆alkylene and particularly preferably C₃-C₄alkylene. Some examples of alkylene are ethylene, 1,2- or 1,3-propylene, 1,2-, 1,3- or 1,4-butylene, pentylene, octylene, decylene and dodecylene. Some examples of R₇ as cycloalkylene are cyclopentylene, cyclohexylene and cyclooctylene. Some examples of R₇ as arylene are phenylene and naphthylene.

R₈ is preferably hydrogen.

The adducts having repeating structural elements of the formulae IV and V are in particular polyethylenamines.

The polymers may be random mixtures of molecules of different chain length. In a preferred embodiment, these polymers contain structural elements of the formula IV and structural elements of the formula V, it being possible for the content of repeating structural elements of the formula IV to be from 50 to 99 mol %, preferably from 70 to 97 mol % and particularly preferably from 75 to 90 mol % and the content of repeating structural elements of the formula V accordingly to be from 50 to 1 mol %, preferably from 30 to 3 mol % and particularly preferably from 25 to 10 mol %, based on 1 mol of the polymer.

In the process according to the invention, oligomeric adducts which may contain, for example, from 3 to 100, preferably from 3 to 60, more preferably from 3 to 30 and particularly preferably from 3 to 15 structural elements of the formula IV and optionally structural elements of the formula V are preferably used. The preferred oligomers may be random mixtures of molecules of different chain lengths. In a particularly preferred embodiment, these oligomers contain structural elements of the formula IV and structural elements of the formula V, it being possible for the content of repeating structural elements of the formula IV to be from 50 to 100 mol %, preferably from 70 to 100 mol % and particularly preferably from 75 to 90 mol % and the content of repeating structural elements of the formula V accordingly to be from 50 to 0 mol %, preferably from 30 to 0 mol % and particularly preferably from 25 to 10 mol %, based on 1 mol of the oligomer or mixtures of oligomers including the terminal groups.

It has furthermore been found that the effect of the polyamines can be further improved if an alkylsilane having organic oxy radicals bonded to the silicon atom and a functional group bonded to the alkyl group is additionally concomitantly used, either as a mixture with the polyamine or as a reaction product with the polyamine. Amino groups of the polyamine and the functional group form a covalently bonded bridging group. The amino groups forming a covalently bonded bridging group may be a primary or secondary amino group, such as, for example, —NH₂, —NH— or —NH(C₁-C₆alkyl), preferably —NH₂, —NH— or —NH(C₁-C₄alkyl). Examples of alkyl have been mentioned above. —NH₂, —NH—, —NH(CH₃) and —NH(C₂H₅) are particularly preferred. In order to achieve the improvement according to the invention, less than the stoichiometric amount, based on the amino groups present, of functional silanes is sufficient, which leads to a particularly economical application.

The functional group may comprise those selected from the group consisting of halogen, (Cl, Br), epoxide, cyanate, isocyanate, —C(O)Cl, —C(O)Br, —C(O)OR₉, —S(O)₂OR₉, —P(O)(OR₉)₂, —P(O)OR₉ or —C(O)NR₁₀R₁₁, in which R₉, R₁₀ and R₁₁, independently of one another, are H or C₁-C₄alkyl. Functional groups which are more preferred are selected from the group consisting of epoxide, isocyanate, cyanate, —C(O)Cl, —C(O)Br and —C(O)OR₉, in which R₉ is H, methyl or ethyl. The epoxide group and also the group —NCO are very particularly preferred. If comonomer units comprising, for example, Cl, —NCO, —CO₂H, —CO₂Cl, —CO₂CH₃, —CO₂C₂H₅ or epoxide groups are present in the polyamines, the functional groups may also be —NH₂ or —OH.

The covalently bonded bridging group formed from amino group and functional group may correspond to the formula —NR₁₂-A-, in which R₁₂ is H or C₁-C₆alkyl and A is a bond, CH₂CH(OH)CH₂, C(O)—O, CH₂(CH₂OH)CH₂, C(O)—NH, C(O), P(O), P(O)(OR₁) or S(O)₂.

The organic oxy radicals bonded to the silicon atom may be C₁-C₁₂alkoxy, preferably C₁-C₈alkoxy, particularly preferably C₁-C₄alkoxy, may be C₅-C₈cycloalkoxy and preferably cyclopentyloxy or cyclohexyloxy, or may be C₆-C₁₀aryloxy and preferably phenoxy.

Examples of alkoxy are methoxy, ethoxy, n-propoxy, isopropoxy, n-butoxy, pentyloxy, hexyloxy, heptyloxy, octyloxy, nonyloxy, decyloxy, undecyloxy and dodecyloxy. Preferred oxy radicals are butoxy, propoxy, ethoxy and in particular methoxy.

The alkyl group of the silane may be C₂-C₁₂alkylene, which may be linear or branched. The alkylene preferably contains from 3 to 8, more preferably from 3 to 6 and particularly preferably from 3 or 4 C atoms. Some examples are ethylene, n-propylene, isopropylene, n-butylene and isobutylene. The alkylene group 1,3-propylene is particularly preferred.

The functional silanes preferably correspond to the formula VI
(R₁₃O)₃—Si—R₁₄—X₁ (VI)
in which
R₁₃ is C₁-C₄alkyl and in particular methyl, R₁₄ is —(CH₂)₃—O—CH₂— and X₁ is an epoxide group of the formula 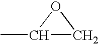
   or R₁₄ is C₂-C₆alkylene and preferably 1,3-propylene, and X₁ is —NCO or —C(O)OR₁₅, in which R₁₅ is hydrogen or C₁-C₄alkyl.

Functional silanes are known and some of them are commercially available. Some examples are 1-trimethoxysilyl-2-carboxyethane, 1-trimethoxysilyl-3-carboxypropane, 1-trimethoxysilyl-2-chloro- or -bromoethane, 1-trimethoxysilyl-3-chloro- or -bromopropane, 1-trimethoxysilyl-3-carboxamidopropane, 1-trimethoxysilyl-3-carbomethoxypropane, 1-trimethoxysilyl-3-isocyanatopropane, 1-trimethoxysilyl-3-cyanatopropane, 1-trimethoxysilyl-3-chloro-carboxypropane and 1-1rimethoxysilyl-3-glycidyloxypropane, which, owing to the reactivity of the epoxide group with respect to amino groups, is particularly preferred.

The invention furthermore relates to a composition comprising (a) at least one low molecular weight, oligomeric or polymeric polyamine having at least 3 amino groups and (b) at least one alkylsilane having organic oxy radicals bonded to the silicon atom and a functional group bonded to the alkyl group, said functional group being capable of forming a covalently bonded bridging group with an amino group of the polyamine.

The above embodiments and preferences are applicable to the polyamines and functional alkylsilanes. The compositions are obtainable in a simple manner by mixing organic polyamines with functional alkylsilanes, optionally in a suitable solvent.

The amount of functional alkylsilanes in the composition is preferably from 1 to 60% by weight, more preferably from 2 to 40% by weight and particularly preferably from 3 to 30% by weight, based on the total amount of polyamine and functional alkylsilane.

The invention also relates to a reaction product obtainable by reacting (1) at least one organic polyamine which has at least three amino groups in the molecule with (2) at least one alkylsilane having organic oxy radicals bonded to the silicon atom and a functional group bonded to the alkyl group, so that said reaction products have on average at least two free amino groups in the molecule, said functional group forming a covalently bonded bridging group with an amino group of the polyamine, with the exception of 4,7,10-triazadecyl-1-trimethoxysilane.

The above embodiments and preferences are applicable to the polyamines and functional alkylsilanes.

The amount of functional alkylsilanes in the reaction product may be from 1 to 60% by weight, preferably from 2 to 40% by weight, particularly preferably from 3 to 30% by weight, based on the total amount of polyamine and functional alkylsilane. The functional alkylsilanes may be bonded to terminal amino groups or to amino groups bonded to oligomer or polymer chains. The reaction products according to the invention also include those in which not all polyamines have been converted, i.e. mixtures of the reaction products with organic polyamines which have at least three amino groups in the molecule. The amount of polyamines in the mixture depends substantially on the amount of functional alkylsilane used.

Preferred reaction products according to the invention are oligomers and polymers having structural elements of the formula VII and optionally structural elements of the formulae VIII and IX 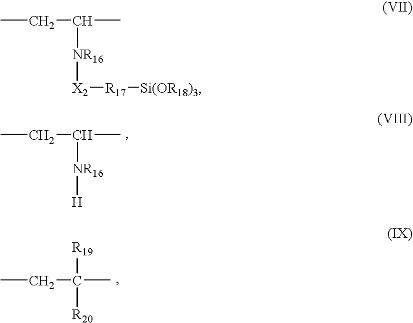
in which
R₁₆ is H or C₁-C₄alkyl,
R₁₇ is C₂-C₆alkylene,
R₁₈ is C₁-C₄alkyl,
X₂ is a direct bond, —C(O)—, —C(O)—O—, —C(O)—NH—, —CH₂CH(OH)CH₂—O— or —CH(CH₂OH)CH₂—O—,
R₁₉ is H or methyl,
R₂₀ is H, C₁-C₁₇alkyl, phenyl, methylphenyl, pyrrolidinyl, Cl, —O—C₁-C₄alkyl. —O—(CO)—C₁-C₄alkyl, —C(O)—OR₂₁ or —C(O)—NR₂₂R₂₃,
R₂₁ is H or C₁-C₁₈alkyl and
R₂₂ and R₂₃, independently of one another, are H or C₁-C₄alkyl.

A particularly preferred subgroup comprises oligomers having structural elements of the formula I and optionally structural elements of the formula II, in which R₁₆ is methyl and preferably H, X₂ is —C(O)—NH— and R₁₇ is 1,3-propylene, or —X₂—R₁₇— is —CH₂CH(OH)CH₂—, and R₁₈ is C₁-C₄alkoxy and preferably methyl.

The amount of structural elements of the formula VII may be, for example, from 0.1 to 100 mol %, preferably from 2 to 50 mol %, more preferably from 3 to 30 mol % and particularly preferably from 5 to 20 mol %, based on 1 mol of an oligomer or polymer. The amount of structural elements of the formula VII may be, for example, from 0 to 99.9 mol %, preferably from 50 to 98 mol %, more preferably from 70 to 97 mol % and particularly preferably from 80 to 95 mol %, based on 1 mol of an oligomer or polymer. The properties of the oligomers and polymers and the performance characteristics thereof can be influenced by a content of structural elements of the formula IX. The structural elements of the formula IX may replace up to 80 mol %, preferably up to 50 mol %, of the structural elements of the formulae VIII and VII.

Oligomers which may contain from 3 to 30, preferably from 3 to 20, more preferably from 3 to 15 and particularly preferably from 3 to 10 structural elements of the formula VII and optionally structural elements of the formula VIII are preferably used in the process according to the invention. The preferred oligomers may be random mixtures of molecules of different chain length. In a particularly preferred embodiment, these oligomers contain structural elements of the formula VII and structural elements of the formula VIII, it being possible for the content of repeating structural elements of the formula VII to be from 1 to 100 mol %, preferably from 5 to 80 mol % and particularly preferably from 5 to 50 mol % and the content of repeating structural elements of the formula VIII accordingly to be from 99 to 0 mol %, preferably from 95 to 20 mol % and particularly preferably from 95 to 5 mol %, based on 1 mol of the oligomer or mixture of oligomers without inclusion of the terminal groups.

Other preferred reaction products are oligomers and polymers which contain repeating structural elements of the formula X and optionally repeating structural elements of the formulae XI, XII, XIII and/or XIV 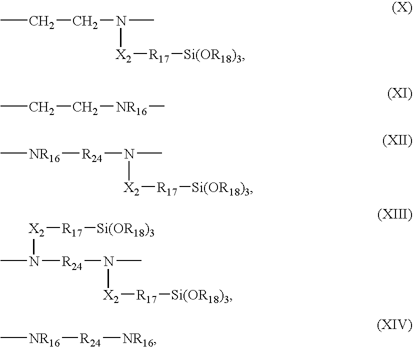
and where terminal groups R₂₅ are bonded to the ends of the oligomer and polymer chains, in which
R₁₆, independently of one another, are H or C₁-C₄alkyl,
R₁₇ is C₂-C₆alkylene,
R₁₈ is C₁-C₄alkyl,
X₂ is a direct bond, —C(O)—, —C(O)—O—, —C(O)—NH—, —CH₂CH(OH)CH₂—O— or —CH(CH₂OH)CH₂—O—,
R₂₄ is C₂-C₁₂alkylene, C₅-C₈cycloalkylene or C₆-C₁₀arylene and
R₂₅ is hydrogen, C₁-C₁₈alkoxy, C₁-C₁₈alkylamino or the group —X₂—R₁₇—Si(OR₁₈)₃.

A particularly preferred subgroup comprises oligomers having structural elements of the formulae X to XIV, in which R₁₆ is methyl and preferably H, X₂ is —C(O)—NH— and R₁₇ is 1,3-propylene, or —X₂—R₁₇— is —CH₂CH(OH)CH₂—O—(CH₂)₃—, R₁₈ is C₁-C₄alkoxy and preferably methyl, R₂₄ is C₂-C₆alkylene and in particular ethylene, and R₂₅ is hydrogen or the group —X₂—R₁₇—Si(OR₁₈)₃.

In the oligomeric and polymeric reaction products according to the invention, alkylsilanes may be bonded to the amino groups of all repeating structural elements. However, it is more advantageous, sufficient for the effect and more economical if only a part of the repeating structural elements contains alkylsilanes in bonded form. The amount of structural elements having bonded alkylsilanes is therefore preferably from 0.1 to 30 mol %, more preferably from 0.5 to 10 mol % and particularly preferably from 1.0 to 5 mol %, based on 1 mol of an oligomer or polymer. Such reaction products are mixtures of polyamines and alkylsilane-modified polyamines.

Preferred reaction products having structural elements of the formulae X to XIV are oligomeric adducts which may contain, for example, from 3 to 100, preferably from 3 to 60, more preferably from 3 to 30 and particularly preferably from 3 to 15 structural elements of the formulae X, XII and/or XIII and optionally structural elements of the formulae XI and XIV. The preferred oligomers may be random mixtures of molecules of different chain length. In a particularly preferred embodiment, the content of repeating structural elements of the formulae X, XII and XIII is from 1 to 100 mol %, preferably from 5 to 60 mol % and particularly preferably from 5 to 40 mol % and the content of repeating structural elements of the formulae XI and XIV is accordingly from 99 to 0 mol %, preferably from 95 to 40 mol % and particularly preferably from 95 to 60 mol %, based on 1 mol of the oligomer or mixture of oligomers with inclusion of the terminal groups.

The preparation of the reaction products according to the invention, having at least two free amino groups, is effected in a manner known per se, in which (a) at least one amino group of a polyamine which contains at least 3 amino groups altogether, is reacted with (b) functional groups of at least one alkylsilane having organic oxy radicals bonded to the silicon atom and a functional group bonded to the alkyl group, with formation of a covalently bonded bridging group. If less than the stoichiometric amount of functional alkylsilane is used, based on reactive amino groups, mixtures of polymeric or oligomeric reaction products may be formed, which mixtures contain the unreacted polyamines and polyamines with bonded alkylsilanes. These mixtures can likewise be used according to the invention for the treatment of wet white with anionic auxiliaries.

Depending on the reactivity of the functional groups, the process can be carried out at from −20 to 200 and preferably from 0 to 100° C. If the functional groups are epoxide or isocyanate, the reaction is advantageously carried out at room temperature.

The reactions can be carried out without or in the presence of an inert solvent, it being possible to use a solvent or mixtures of solvents. Suitable solvents are, for example, aliphatic, cycloaliphatic and aromatic hydrocarbons (pentane, hexane, petroleum ether, cyclohexane, methylcyclohexane, benzene, toluene, xylene), aliphatic halohydrocarbons (methylene chloride, chloroform, di- and tetrachloroethane), nitriles (acetonitrile, propionitrile, benzonitrile), ethers (diethyl ether, dibutyl ether, tert-butyl methyl ether, ethylene glycol dimethyl ether, ethylene glycol diethyl ether, diethylene glycol dimethyl ether, tetrahydrofuran, dioxane, diethylene glycol monomethyl or monoethyl ether), carboxylic esters and lactones (ethyl or methyl acetate, valerolactone), N-substituted lactams (N-methylpyrrolidone), carboxamides (dimethylacetamide, dimethylformamide), acyclic ureas (dimethylimidazoline), sulphoxides and sulphones (dimethyl sulphoxide, dimethyl sulphone, tetramethylene sulphoxide, tetramethylene sulphone) and alcohols (methanol, ethanol, propanol, butanol, ethylene glycol monomethyl ether, ethylene glycol monoethyl ether, ethylene glycol monobutyl ether, diethylene glycol monomethyl ether, ethylene glycol, diethylene glycol monobutyl ether, 1,3-propanediol, 1,4-butanediol).

The process can be carried out in a simple manner, so that the polyamine and optionally the solvent are initially introduced, the alkylsilane is added either completely or in portions and then stirring is effected to complete the reaction. After the end of the reaction, the reaction product can be isolated by removing the solvent, for example by distillation, optionally in vacuo. The reaction product can also advantageously be used directly in liquors for the treatment of fibrous materials or leather and skins, there being no need to remove the solvent beforehand.

Reaction products according to the invention are also obtainable by polymerization of monomers if the functional group of the alkylsilane is first bonded to the amino group of a polymerizable monomeric amine, and the monomer thus modified is polymerized alone or together with comonomers.

The reaction products according to the invention can be isolated by known methods and, if desired, purified, for example by removal of the solvent, spray-drying, precipitation by addition of nonsolvents and filtration and washing of the residues with nonsolvents.

The reaction products and compositions according to the invention are materials of liquid to solid consistency, which are soluble, emulsifiable or dispersible as microparticles in aqueous liquors for the treatment of wet white. The consistency depends substantially on the molecular weight and on the monomers and comonomers chosen for the oligomers and polymers.

The reaction products, compositions and organic polyamines having at least three free amino groups, according to the invention, are outstandingly suitable as auxiliaries in the ready-to-use finish of wet white in aqueous liquors which have a pH of about 14 to 3.5 and preferably 8 to 4. The reaction products, compositions and organic polyamines can be added as such to the liquors. However, it is more advantageous to use formulations in order to achieve a more rapid distribution in the liquor.

The reaction products and compositions according to the invention are outstandingly suitable as auxiliaries in the ready-to-use finish of fibrous materials, such as, for example, textiles, mineral tanned and optionally retanned leathers or skins in aqueous liquors which have a pH of about 10 to 2.5 and preferably 8 to 3.5. The reaction products, compositions and organic polyamines can be added as such to the liquors.

The invention furthermore relates to a composition comprising (1a) at least one organic polyamine having at least three free amino groups, (1b) at least one reaction product according to the invention or a composition according to the invention, (2) a carrier for the components (1a) and (1b) and (3) optionally further additives.

The abovementioned preferences and embodiments are applicable to the organic polyamines having at least three free amino groups and reaction products and compositions (1b) according to the invention.

The choice of the carrier depends substantially on the desired dosage form. It may comprise solid and preferably liquid carriers. Suitable liquid carriers are solvents or mixtures of solvents, for example those mentioned above. Preferred carriers are alcohols, such as, for example, the C₁-C₆alkanols, mono- or diethylene glycol C₁-C₆alkyl ethers, C₂-C₆diols and ethylene glycol or diethylene glycol. Aqueous solutions of the reaction products or compositions are also particularly advantageous. Acids, for example mineral acids (hydrochloric acid, sulphuric acid, phosphorous acid and phosphoric acid) or organic acids, for example sulphonic acids, phosphonic acids and carboxylic acids, for example formic acid and acetic acid, are expediently concomitantly used here for improving solubility.

The composition according to the invention may be present as a solution, emulsion or dispersion in an organic solvent. Solutions, emulsions and dispersions may additionally contain surfactants or stabilizers, for example in an amount of from 0.1 to 20% by weight, based on the composition. Surfactants are widely known. Neutral surfactants are preferred.

The compositions according to the invention may be present in dilute form or as concentrates. The amount of component (1) may be, for example, from 0.1 to 80% by weight, preferably from 5 to 70% by weight and particularly preferably from 10 to 60% by weight, based on the composition.

The preparation of the composition according to the invention can be effected in a simple manner by dissolving, emulsifying or dispersing the agents in the carrier, optionally with stirring, heating or stirring and heating. Microparticles of solid agents can be prepared in a known manner by means of milling or spray-drying. In the reaction of epoxy-functional or isocyanate-functional alkylsilanes with a polyamine for the formation of reaction products, no reaction auxiliaries need be used, owing to the reactivity of these functional groups with respect to amino groups, so that the reaction products are obtained in high purity. These reaction products can therefore advantageously be used in the solvent used for the reaction, directly in liquors for the treatment of leather or skins.

The composition (formulation) according to the invention is used, for example, in amounts such that the components (1a) or (1b) are present in the liquor in an amount of from 0.1 to 30, preferably from 0.1 to 20, more preferably from 0.1 to 15, particularly preferably from 0.5 to 10 and especially preferably from 0.5 to 5, % by weight, based on the shaved weight of the leather. Polyamines, and compositions or reaction products according to the invention, having a functional silane, are used in the same quantity ranges.

The process according to the invention is particularly suitable for the treatment of leathers and furs pretanned and/or retanned with organic tanning agents in the absence of metals, and in particular wet white.

The process according to the invention can be carried out by a procedure in which the leather is added to an aqueous liquor, and the anionic auxiliary and at the same time an organic polyamine and/or a composition according to the invention or a reaction product is then added to the liquor and allowed to act on the leather. Alternatively, the leather can first be treated in an aqueous acidic liquor with the anionic auxiliary and then with a compound according to the invention which contains amino groups. In this alternative, it may be more expedient to discharge the liquor after the treatment with the anionic auxiliary, optionally to wash the leather and to carry out the treatment with a compound according to the invention which contains amino groups in a fresh aqueous liquor. A further alternative comprises first treating the leather with an organic polyamine and/or a reaction product or composition according to the invention and then allowing the anionic auxiliary to act. In this alternative, it may be more expedient to discharge the liquor after the treatment with the organic polyamine and/or a reaction product/composition according to the invention, optionally to wash the fibrous material and to carry out the treatment with the anionic auxiliary in a fresh aqueous liquor. The treatment can be carried out at elevated temperatures, for example up to 60°, preferably at about 40° C. However, a treatment at room temperature is often sufficient. The treatment time may be, for example, from 10 minutes to 2 hours, times of less than one hour often being sufficient. After the treatment, aftertreatment is expediently effected by means of the addition of an acid, for example formic acid, and the liquor is then discharged. The leather can then be used for the further finishing for completion.

The invention also relates to the use of organic polyamines having at least three amino groups, a reaction product according to the invention, a composition according to the invention or a composition (formulation) according to the invention as an auxiliary in the finishing of wet white with anionic auxiliaries.

An action of the anionic auxiliary which is uniform over the surface, in a combination with strong fixing to the fibrous substrate, is achieved by means of the process according to the invention. The fibrous materials thus produced are therefore distinguished by excellent wet strength, so that the auxiliaries exhibit virtually no bleeding in the further finishing in the wet process and the properties obtained are retained. The process is moreover very economical since, in relation to the polyamine groups, a considerably smaller amount of silane groups has to be introduced in order to obtain the desired effects. Consequently, other desired properties of the substrate are also influenced only to an insignificant extent, if at all. The exhaustion of the liquor is considerably better. The good fastness to perspiration which can be achieved in the case of wet white leather should be singled out in particular.

The examples which follow illustrate the invention in more detail.

A) Preparation of Reaction Products According to the Invention

### EXAMPLE A1

### Reaction of an Oligomeric Ethylenamine with 1-trimethoxysilyl-3-glycidyloxypropane

The polyamine used is a commercial oligomeric ethylenamine which comprises about 0.4 percent by weight of tetramines, about 90.4 percent by weight of pentamines, hexamines and heptamines and about 9% by weight of higher amines. 57.69 parts by weight of diethylene glycol monobutyl ether are initially introduced into a glass flask having a condenser and magnetic stirrer. 38.46 parts of oligomeric polyamine and 3.85 parts by weight of 1-trimethoxysilyl-3-glycidyloxypropane are then added in succession. The clear solution is stirred for 4 hours at room temperature and is used without further purification in example B2. The course of the reaction can be monitored by means of thin-layer chromatography on thin-layer chromatography sheets pretreated with ammonia (Polygran SIL G/UV₂₅₄ Macherey and Nagel), mobile phase water, and subsequent visualization by means of UV light with wavelengths of 254 and 366 nm. A brown, oily product is obtained in quantitative yield.

B) Use Examples

### EXAMPLE B1

### Dyeing of Leather with the Anionic Dye of the Formula XV

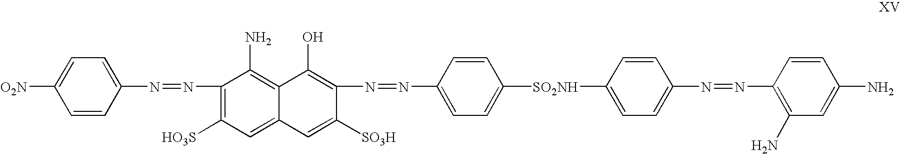 A) Dyeing of the Leather

100 parts by weight of organically pretanned, retanned, fatliquored and dried leather (‘wet white crust’) are washed for 30 minutes with 600 parts by weight of water at 40° C. and then treated for 5 minutes with 1.5 parts by weight of ammonium bicarbonate and 1 part by weight of a formulation of ethoxylated amines, fatty alcohols and salts of aromatic sulphonic acids, which formulation has a levelling effect (trade name of the formulation: IN-VADERM B®, TFL). Thereafter, 4 parts by weight of the above anionic dye are allowed to act on the leather for 60 minutes, 100 parts by weight of water at 50° C and 2 parts by weight of formic acid are then added and the leather is treated for a further 30 minutes. By adding a further 2 parts by weight of formic acid, the pH is reduced to a value of about 3.3. The action is allowed to continue for a further 30 minutes and the liquor is then removed. The leather is then washed with 600 parts by weight of water at 25° C. and the wash water is removed.

b) Treatment with an Oligomeric Ethylenamine

Fresh liquor is prepared from 600 parts by weight of water at 25° C., and 4 parts by weight of a formulation of 38.5 parts by weight of the polyamine described as starting material in preparation example A1 and 61.5 parts by weight of diethylene glycol monobutyl ether are added and the leather is treated for 30 minutes at 25° C and a pH of about 6 to 7. For reducing the pH to about 3.5, 2 parts by weight of formic acid are then added, said acid being allowed to act for a further 15 minutes. The liquor is then removed again. Finally, the leather is washed with 200 parts by weight of water at 25° C. for 10 minutes. A leather which has been dyed black and has—for a leather tanned in the absence of metals—very good wet fastness and which can be finished in the customary manner is obtained.

### EXAMPLE B2

### Dyeing of Leather with the Anionic Dye of the Formula XV

a) Dyeing of the Leather

Analogous to Example B1a.

b) Treatment with the Reaction Product of Example A1

Fresh liquor is prepared from 600 parts by weight of water and 4 parts by weight of the formulation (reaction product) described in preparation example A1 and the leather is treated for 30 minutes at 25° C. and a pH of about 6 to 7. For reducing the pH to about 3.5, 2 parts by weight of formic acid are then added, said acid being allowed to act for a further 15 minutes. The liquor is then removed again. Finally, the leather is washed with 200 parts by weight of water at 25° C. for 10 minutes. A leather which has been dyed black and once again has improved wet fastness compared with the leather obtained according to example B1b and which can be finished in the customary manner is obtained.

### EXAMPLES B3-B14

In the examples, the following formulations of polyamines are used (parts are parts by weight):

Formulation F1

A commercial oligomeric ethylenamine which comprises about 0.4 percent by weight of tetramines, about 90.4 percent by weight of pentamines, hexamines and heptamines and about 9% by weight of higher amines is used as the polyamine (polyamine B).

Formulation F2

38.5 parts of polyamine B are neutralized, with cooling in a glass flask having a stirrer and reflux condenser, by slow addition of 31.6 parts of tap water and of 29.9 parts of 85% strength formic acid to a pH of 6.9. The clear solution is stirred and then used without further purification.

Formulation F3

77.0 parts of polyamine B are added to 23.0 parts of diethylene glycol monobutyl ether in a glass flask having a stirrer and reflux condenser. The clear solution is stirred and then used without further purification.

Formulation F4

The polyamine used is an aqueous solution of a commercial modified ethylenamine which has a weight average molar mass of 5 000 g/mol.

Formulation F5

The polyamine used is an aqueous solution of a commercial modified ethylenamine which has a weight average molar mass of 800 g/mol.

Formulation F6

The polyamine used is an aqueous solution of a commercial modified ethylenamine which has a weight average molar mass of 2 000 000 g/mol.

### EXAMPLE B3

### Dyeing of Leather with Anionic Dye of the Formula XV

a) Dyeing of the Leather with Top Dyeing:

200 parts by weight of water are added to 100 parts by weight of organically pretanned leather (‘wet white’). After the addition of 0.5 part by weight of sodium formate and 0.5 part by weight of sodium bicarbonate, washing is effected for 10 minutes at 30° C. Tanning is then completed with 5 parts by weight of a commercial synthetic liquid tanning agents at 30° C. for 20 minutes. Preliminary fatliquoring is then effected with 5 parts by weight of commercial fatliquoring agents at 30° C. for 20 minutes. The leather is then retanned again by the addition of 25 parts by weight of commercial synthetic liquid tanning agents and 4 parts by weight of tara. Directly thereafter, 3 parts by weight of the above anionic dye are allowed to act for 120 minutes at 30° C. The dye is then prefixed with 0.8 part by weight of formic acid, the pH being reduced to a value of 3.9. After the liquor has been removed, washing is effected with 200 parts by weight of water at 50° C. for 10 minutes.

The fatliquoring of the leather is effected in a fresh liquor at 50° C. for 60 minutes after the addition of 100 parts by weight of water at 50° C. and 14 parts by weight of commercial fatliquoring agents. The fixing with acid is effected in two steps. First, 1 part by weight of formic acid is added at 50° C. and, after 30 minutes, a further 1 part by weight of formic acid is added at a constant temperature and allowed to act for 30 minutes. The resulting pH is 3.5-3.3. The liquor is then removed.

A fresh liquor is prepared from 200 parts by weight of water (50° C.) and 0.3 part by weight of formic acid, in order to treat the leather for 10 minutes. The top dyeing is effected with 1 part by weight of the above anionic dye for 30 minutes. Acidification is then effected with 1 part by weight of formic acid and the liquor is allowed to act for a further 30 minutes, the resulting pH being about 3.0. The liquor is removed and finally the leather is washed with 200 parts by weight of water at 50° C. for 10 minutes.

b1) Treatment with Formulation F1

The dyed leather is treated for 10 minutes with 100 parts by weight of water at 40° C. and 1 part by weight of formic acid. This is followed by the fixing of the dye by addition of 2.3 parts by weight of formulation F1 at 40° C. and an action time of 60 minutes. The pH increases slightly to 3.8. Finally, fixing is effected with 1 part by weight of formic acid in 30 minutes. A leather which has been dyed black and has improved wet fastness compared with the leather obtained according to examples B3b2 and B3b3 and a more intense dyeing is obtained. Finishing is effected in the customary manner.

b2) Treatment with Commercial Fixing Agent

The dyed leather is treated for 10 minutes with 100 parts by weight of water at 40° C. and 1 part by weight of formic acid. This is followed by the fixing of the dye by addition of 2 parts by weight of a conventional commercial fixing agent (trade name SELLAFIX® FRD liq.) at 40° C. and for an action time of 60 minutes. A leather which has been dyed black and has poorer wet fastness compared with the leather obtained according to examples B3b1, B4b and B5b and a lower intensity of the dye is obtained. Finishing is effected in the customary manner.

b3) Without Fixing Agent

The leather is further processed after the dyeing process without addition of fixing agent. A leather which has been dyed black and has a poorer wet fastness and a poorer dyeing compared with examples B3b1, B4b, B5b and, to a lesser extent, B3b2 is obtained.

### EXAMPLE B4

### Dyeing of Leather with Anionic Dye of the Formula XV

a) Dyeing of the Leather with Top Dyeing

Analogous to Example B3a.

b) Treatment with Formulation F2

The dyed leather is treated for 10 minutes with 100 parts by weight of water at 40° C. and 1 part by weight of formic acid. This is followed by the fixing of the dye by addition of 4 parts by weight of formulation F2 at 40° C. and an action time of 60 minutes. The pH increases slightly to 3.8. Finally, fixing is effected with 1 part by weight of formic acid in 30 minutes. A leather which has been dyed black and has improved wet fastness compared with the leather obtained according to examples B3b2 and B3b3 and a more intense dyeing is obtained. Finishing is effected in the customary manner.

### EXAMPLE B5

### Dyeing of Leather with Anionic Dye of the Formula XV

a) Dyeing of the Leather with Top Dyeing

Analogous to Example B3a.

b) Treatment with Formulation F3

The dyed leather is treated for 10 minutes with 100 parts by weight of water at 40° C. and 1 part by weight of formic acid. This is followed by the fixing of the dye by addition of 2 parts by weight of formulation F3 at 40° C. and an action time of 60 minutes. The pH increases slightly to 3.8. Finally, fixing is effected with 1 part by weight of formic acid in 30 minutes. A leather which has been dyed black and has improved wet fastness compared with the leather obtained according to examples B3b2 and B3b3 and a more intense dyeing is obtained. Finishing is effected in the customary manner.

### EXAMPLE B6

### Dyeing of Leather with Anionic Dye of the Formula XV

a) Dyeing of the Leather with Top Dyeing

Analogous to Example B3a.

b) Treatment with Formulation F4

The dyed leather is treated for 10 minutes with 100 parts by weight of water at 40° C. and 1 part by weight of formic acid. This is followed by the fixing of the dye by addition of 3.2 parts by weight of formulation F4 at 40° C. and an action time of 60 minutes. The pH increases slightly to 3.7. Finally, fixing is effected with 1 part by weight of formic acid in 30 minutes. A leather which has been dyed black and has improved wet fastness compared with the leather obtained according to examples B3b2 and B3b3 and a more intense dyeing is obtained. Finishing is effected in the customary manner.

### EXAMPLE B7

### Dyeing of Leather with Anionic Dye of the Formula XV

a) Dyeing of the Leather with Top Dyeing

Analogous to Example B3a.

b) Treatment with Formulation F5

The dyed leather is treated for 10 minutes with 100 parts by weight of water at 40° C. and 1 part by weight of formic acid. This is followed by the fixing of the dye by addition of 3.2 parts by weight of formulation F5 at 40° C. and an action time of 60 minutes. The pH increases slightly to 4.0. Finally, fixing is effected with 1 part by weight of formic acid in 30 minutes. A leather which has been dyed black and has improved wet fastness compared with the leather obtained according to examples B3b2 and B3b3 and a more intense dyeing is obtained. Finishing is effected in the customary manner.

### EXAMPLE B8

### Dyeing of Leather with Anionic Dye of the Formula XV

a) Dyeing of the Leather with Top Dyeing

Analogous to Example B3a.

b) Treatment with Formulation F6

The dyed leather is treated for 10 minutes with 100 parts by weight of water at 40° C. and 1 part by weight of formic acid. This is followed by the fixing of the dye by addition of 3.2 parts by weight of formulation F6 at 40° C. and an action time of 60 minutes. The pH increases slightly to 3.6. A leather which has been dyed black and has improved wet fastness compared with the leather obtained according to examples B3b2 and B3b3 and a more intense dyeing is obtained. Finishing is effected in the customary manner.

### EXAMPLE B9

### Dyeing of Leather with Anionic Dye of the Formula XV

a) Dyeing of the Leather Without Top Dyeing

200 parts by weight of water are added to 100 parts by weight of organically pretanned leather (‘wet white’). After addition of 0.5 part by weight of sodium formate and 0.5 part by weight of sodium bicarbonate, the liquor is allowed to act for 10 minutes at 30° C. Tanning is then completed with 5 parts by weight of commercial synthetic liquid tanning agents at 30° C. for 20 minutes. The preliminary fatliquoring is effected with 5 parts by weight of commercial fatliquoring agents for 20 minutes at 30° C. The leather is then retanned by adding 25 parts by weight of commercial synthetic liquid tanning agents and 4 parts by weight of tara. Directly thereafter, 3 parts by weight of the above anionic dye is allowed to act for 120 minutes at 30° C. The dye is then prefixed with 0.8 part by weight of formic acid, the pH being reduced to a value of 3.9. After the liquor has been removed, washing is effected with 200 parts by weight of water at 50° C. for 10 minutes. The fatliquoring of the leather is effected at 50° C. for 60 minutes in a fresh liquor after the addition of 100 parts by weight of water at 50° C. and 14 parts by weight of commercial fatliquoring agent. The fixing with acid is effected in two steps. First, 1 part by weight of formic acid is added at 50° C. and, after 30 minutes, a further 1 part of formic acid is added at 50° C. and allowed to act for 30 minutes. The resulting pH is 3.3-3.5. The liquor is removed and finally the leather is washed with 200 parts by weight of water at 50° C. for 10 minutes.

b1) Treatment with Formulation F1

The dyed leather is treated for 10 minutes with 100 parts by weight of water at 40° C. and 1 part by weight of formic acid. This is followed by the fixing of the dye by addition of 1.6 parts by weight of formulation F1 at 40° C. and an action time of 60 minutes. The pH increases slightly to 3.8. Finally, fixing is effected with 1 part by weight of formic acid in 30 minutes. A leather which has been dyed black and has improved wet fastness compared with the leather obtained according to examples B9c and B9d and a more intense dyeing is obtained. Finishing is effected in the customary manner.

b2) Treatment with Commercial Fixing Agent

The dyed leather is treated for 10 minutes with 100 parts by weight of water at 40° C. and 1 part by weight of formic acid. This is followed by the fixing of the dye by addition of 4 parts by weight of a conventional commercial fixing agent. (trade name SELLAFIX® FRD liq.) at 40° C. and for an action time of 60 minutes. A leather which has been dyed black and has poorer wet fastness compared with the leather obtained according to example B9b1 and a lower intensity of the dye is obtained. Finishing is effected in the customary manner.

b3) Without Fixing Agent

The leather is further processed after the dyeing process without addition of fixing agent. A leather which has been dyed black and has a poorer wet fastness and a poorer dyeing compared with examples B9b1, B10b, B11b and, to a lesser extent, B9b2 is obtained.

### EXAMPLE B10

### Dyeing of Leather with Anionic Dye of the Formula XV

a) Dyeing of the Leather Without Top Dyeing

Analogous to Example B9a.

### b) Treatment with Formulation F2

The dyed leather is treated for 10 minutes with 100 parts by weight of water at 40° C. and 1 part by weight of formic acid. This is followed by the fixing of the dye by addition of 4 parts by weight of formulation F2 at 40° C. and an action time of 60 minutes. The pH increases slightly to 3.8. Finally, fixing is effected with 1 part by weight of formic acid in 30 minutes. A leather which has been dyed black and has improved wet fastness compared with the leather obtained according to examples B9b2 and B9b3 and a more intense dyeing is obtained. Finishing is effected in the customary manner.

### EXAMPLE 11

### Dyeing of Leather with Anionic Dye of the Formula XV

a) Dyeing of the Leather Without Top Dyeing

Analogous to Example B9a.

b) Treatment with Formulation F3

The dyed leather is treated for 10 minutes with 100 parts by weight of water at 40° C. and 1 part by weight of formic acid. This is followed by the fixing of the dye by addition of 2 parts by weight of formulation F3 at 40° C. and an action time of 60 minutes. The pH increases slightly to 3.8. Finally, fixing is effected with 1 part by weight of formic acid in 30 minutes. A leather which has been dyed black and has improved wet fastness compared with the leather obtained according to examples B9b2 and B9b3 and a more intense dyeing is obtained. Finishing is effected in the customary manner.

### EXAMPLE B12

### Dyeing of Leather with Anionic Dye of the Formula XV

a) Dyeing of the Leather Without Top Dyeing

Analogous to Example B9a.

b) Treatment with Formulation F4

The dyed leather is treated for 10 minutes with 100 parts by weight of water at 40° C. and 1 part by weight of formic acid. This is followed by the fixing of the dye by addition of 3.2 parts by weight of formulation F4 at 40° C. and an action time of 60 minutes. Finally, fixing is effected with 1 part by weight of formic acid in 30 minutes. A leather which has been dyed black and has improved wet fastness compared with the leather obtained according to examples B9b2 and B9b3 and a more intense dyeing is obtained. Finishing is effected in the customary manner.

### EXAMPLE B13

### Dyeing of Leather with Anionic Dye of the Formula XV

a) Dyeing of the Leather Without Top Dyeing

Analogous to Example B9a.

b) Treatment with Formulation F5

The dyed leather is treated for 10 minutes with 100 parts by weight of water at 40° C. and 1 part by weight of formic acid. This is followed by the fixing of the dye by addition of 3.2 parts by weight of formulation F5 at 40° C. and an action time of 60 minutes. The pH increases slightly to 3.8. Finally, fixing is effected with 1 part by weight of formic acid in 30 minutes. A leather which has been dyed black and has improved wet fastness compared with the leather obtained according to examples B9b2 and B9b3 and a more intense dyeing is obtained. Finishing is effected in the customary manner.

### EXAMPLE B14

### Dyeing of Leather with Anionic Dye of the Formula XV

a) Dyeing of the Leather Without Top Dyeing

Analogous to Example B9a.

b) Treatment with Formulation F6

The dyed leather is treated for 10 minutes with 100 parts by weight of water at 40° C. and 1 part by weight of formic acid. This is followed by the fixing of the dye by addition of 2 parts by weight of formulation F6 at 40° C. and an action time of 60 minutes. Finally, fixing is effected with 1 part by weight of formic acid in 30 minutes. A leather which has been dyed black and has improved wet fastness compared with the leather obtained according to examples B9b2 and B9b3 and a more intense dyeing is obtained. Finishing is effected in the customary manner.

### EXAMPLE B15

### Dyeing of Vegetable Tanned Leather with the Anionic Dye of the Formula XV

a) Dyeing of the Leather Without Top Dyeing

600 parts by weight of water are added to 600 parts by weight of vegetable tanned, retanned and fatliquored leather (‘crust’). After addition of 0.8 part by weight of oxalic acid, 0.8 part by weight of ethylenediaminetetraacetic acid (EDTA) and 0.8 part by weight of a 30% strength solution of an anionic surfactant in water, the liquor is allowed to act for 60 minutes at 35° C. After the liquor has been discharged, washing is effected with a further 600 parts by weight of water at 25° C. for 10 minutes and once again the liquor is discharged. A fresh bath of 300 parts by weight of water and 2 parts by weight of a formulation of ethoxylated fatty amines with fatty alcohols and salts of aromatic sulphonic acids, which formulation has a levelling effect, is allowed to act at 30° C. for 10 minutes, and 5 parts by weight of the dye of the formula XV are then added. After 90 minutes, the pH is reduced to a value of 3 by adding 2.5 parts by weight of formic acid. After the dye liquor has been discharged, the fatliquoring is effected in a fresh bath of 400 parts by weight of water at 45° C. and 9 parts by weight of commercial fatliquoring agents for 60 minutes. By adding two portions each of 1 part by weight of formic acid, acidification is then effected to a pH of 2.8. The liquor is again discharged, washing is effected with 300 parts by weight of water at 45° C. for 10 minutes and the liquor is again discharged.

b1) Treatment with Formulation F1

The fixing of the dye is effected in a fresh bath of 300 parts by weight of water by addition of 1.5 parts by weight of formulation F1 at 20° C. and for an action time of 30 minutes. The pH is then reduced to a value of 3.7 by adding 2 parts by weight of formic acid. Finally, 2 parts by weight of a sequestering agent are added and allowed to act for 30 minutes. A leather which has been dyed black and has only slightly improved fastness to perspiration compared with the leather obtained according to example B15b2 is obtained. Finishing is effected in the customary manner.

b2) Treatment with Commercial Fixing Agent

The fixing of the dye is effected in a fresh bath of 300 parts by weight of water by addition of 1.5 parts by weight of a commercial fixing agent (trade name SELLA FIX FRD®) at 20° C. and for an action time of 30 minutes. Finally, 2 parts by weight of a sequestering agent are added and allowed to act for 30 minutes. A leather which has been dyed black and has only slightly poorer fastnesses to perspiration compared with the leather obtained according to example B15b1 is obtained. Finishing is effected in the customary manner.

C) Use Examples of Performance Characteristics

### EXAMPLE C1

### Testing of the Fastness to Perspiration

The test is carried out according to ISO 11641 by comparison with the corresponding grey scale. S is the change in the shade of the leather as a result of the test, CO is the soiling of a cotton felt and WO is the soiling of a wool felt. The results are shown in tables 1 and 2.

TABLE 1

| Example with top dyeing | S | WO | CO |
|---|---|---|---|
| B3b1 | 4 | 3-4 | 3 |
| B4b | 3 | 3 | 2-3 |
| B5b | 3-4 | 3-4 | 3 |
| B6b | 3-4 | 3-4 | 3 |
| B7b | 3 | 3-4 | 3-4 |
| B8b | 3-4 | 3 | 3 |
| B3b2 (comparison) | 3 | 1-2 | 1 |
| B3b3 (comparison) | 2 | 1 | 1 |

The rating ranges from 1 to 5, 1 being the poorest rating.

TABLE 2

| Example without top dyeing | S | WO | CO |
|---|---|---|---|
| B9b | 2-3 | 4 | 4 |
| B10b | 2-3 | 4 | 4 |
| B11b | 3-4 | 4 | 3-4 |
| B12b | 4 | 4 | 3-4 |
| B13b | 3-4 | 4 | 4 |
| B14b | 4 | 3-4 | 2-3 |
| B9b2 (comparison) | 2 | 2-3 | 1-2 |
| B9b3 (comparison) | 2 | 2-3 | 1-2 |
| B15b1 (comparison) | 4 | 2-3 | 1-2 |
| B15b2 (comparison) | 3-4 | 2 | 1 |

The rating ranges from 1 to 5, 1 being the poorest rating.

1. Process for the treatment of leathers or skins, pretanned with dialdehydes and retanned with organic tanning agents, with anionic reagents in an aqueous liquor, in which
a) either an anionic reagent together with at least one organic polyamine having at least three amino groups in the molecule, or mixtures or reaction products (1) of such polyamines with (2) at least one alkylsilane having organic oxy radicals bonded to the silicon atom and a functional group bonded to the alkyl group so that said reaction products have at least two free amino groups in the molecule, said functional group forming covalently bonded bridging groups with an amino group of the polyamine, are added to the liquor and allowed to act on the leather,
b) or the leather is first treated with anionic reagents and then, in the same or a fresh liquor, at least one organic polyamine having at least three amino groups in the molecule, or mixtures or reaction products (1) of such polyamines with (2) at least one alkylsilane having organic oxy radicals bonded to the silicon atom and a functional group bonded to the alkyl group so that said reaction products have at least two free amino groups in the molecule, said functional group forming a covalently bonded bridging group with an amino group of the polyamine, is or are allowed to act on the treated material,
c) or the leather is first treated with an organic polyamine having at least three amino groups in the molecule, or mixtures or reaction products (1) of such polyamines with (2) at least one alkylsilane having organic oxy radicals bonded to the silicon atom and a functional group bonded to the alkyl group so that said reaction products have at least two free amino groups in the molecule, said functional group forming a covalently bonded bridging group with an amino group of the polyamine, and the anionic reagents are then allowed to act on the treated material in the same or a fresh liquor.

2. Process according to claim 1, characterized in that the anionic reagents are fatliquoring agents, water repellents, organic tanning and retanning agents or dyes which have at least one acidic group.

3. Process according to claim 1, characterized in that the anionic auxiliaries are used in an amount of from 0.1 to 30% by weight, based on the shaved weight of the leather or the skins.

4. Process according to claim 1, characterized in that the auxiliary is an anionic dye.

5. Process according to claim 1, characterized in that the polyamines are low molecular weight, oligomeric or polymeric compounds which are soluble in polar solvents and also in water.

6. Process according to claim 1, characterized in that the low molecular weight polyamines are saturated or unsaturated, open-chain, mono- or polycyclic compounds which contain 6 to 30 C atoms.

7. Process according to claim 1, characterized in that the polyamines are oligomers or polymers in which the amino groups are bonded either directly or via a bridging group to the polymer backbone or in the polymer backbone.

8. Process according to claim 7, characterized in that the oligomers contain from 3 to 100, preferably from 3 to 50 and particularly preferably from 3 to 30 and the polymers more than 100 and up to about 28 000 identical or different monomer units.

9. Process according to claim 7, characterized in that the oligomers and polymers contain at least one repeating structural element of the formula II and optionally at least one repeating structural element of the formula III 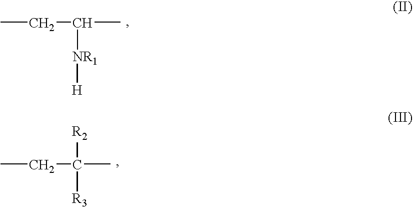
in which
R₁ is H or C₁-C₄alkyl,
R₂ is H or methyl,
R₃ is H, C₁-C₁₇alkyl, phenyl, methylphenyl, pyrrolidinyl, Cl, —O—C₁-C₄alkyl, —O—(CO)—C₁-C₄alkyl, —C(O)—OR₄ or —C(O)—NR₅R₆,
R₄ is H or C₁-C₁₈alkyl and
R₅ and R₆, independently of one another, are H or C₁-C₄alkyl.

10. Process according to claim 7, characterized in that the oligomers and polymers are adducts of organic diamines and aziridine or a polyethylenamine.

11. Process according to claim 10, characterized in that the adducts contain repeating structural elements of the formula IV and optionally repeating structural elements of the formula V
—NR₁₆CH₂—CH₂)— (IV),
—NR₁₆—R₇—NR₁₆— (V),
terminal groups R₈ being bonded to the ends of the chains, in which
R₇ is C₂-C₁₂alkylene, C₅-C₈cycloalkylene or C₆-C₁₀arylene,
R₈ is hydrogen, C₁-C₁₈alkoxy or C₁-C₁₈alkylamino and
the R₁₆, independently of one another, are H or C₁-C₄alkyl.

12. Process according to claim 11, characterized in that the adducts are oligomers having 3 to 15 structural elements of the formula IV and optionally repeating structural elements of the formula V.

13. Process according to claim 11, characterized in that the content of repeating structural elements of the formula IV is from 50 to 100 mol % and the content of repeating structural elements of the formula V is from 50 to 0 mol %.

14. Process according to claim 1, characterized in that an alkylsilane having organic oxy radicals bonded to the silicon atom and a functional group bonded to the alkyl group is additionally concomitantly used, either as a mixture with the polyamine or as a reaction product with the polyamine, the amino groups of the polyamine and the functional group together forming a covalently bonded bridging group.

15. Process according to claim 14, characterized in that the functional silane corresponds to the formula VI,
(R₁₃O)₃—Si—R₁₄—X₁ (VI)
in which
R₁₃ is C₁-C₄alkyl and in particular methyl, R₁₄ is —(CH₂)₃—O—CH₂— and X₁ is an epoxide group of the formula 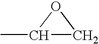
or R₁₄ is C₂-C₆alkylene and X₁ is —NCO or —C(O)OR₁₅, in which R₁₅ is hydrogen or C₁-C₄alkyl.

16. Process according to claim 15, characterized in that the amount of functional alkylsilanes in the composition with the polyamine is preferably from 1 to 60% by weight, based on the total amount of polyamine and functional alkylsilane.

17. Process according to claim 1, characterized in that the polyamine or the mixture or reaction product of polyamine and alkylsilane is used in an amount of from 0.1 to 30% by weight, based on the shaved weight of the fibrous material.

18. Process according to claim 1, which is carried out at from room temperature to 60° C.

19-34. (canceled)
